(19) United States
(12) Patent Application Publication
(10) Pub. No.: US 2018/0056534 A1
(43) Pub. Date: Mar. 1, 2018

(54) Barber Pencil

(71) Applicant: Wendell Quincy Reed, Cincinnati, OH (US)

(72) Inventor: Wendell Quincy Reed, Cincinnati, OH (US)

(21) Appl. No.: 15/246,629

(22) Filed: Aug. 25, 2016

(51) Int. Cl. B26B 19/14; B26B 19/38

(52) U.S. Cl. CPC B26B 19/148; B26B 19/3886; B26B 19/388

(57) ABSTRACT

A rounded head hair trimmer for trimming hair. The hair trimmer comprises a handheld cylindrical body with a motor and an arrangement for controlling electric supply to the motor. A rounded cutting head is coupled to the motor. The cutting head includes a plurality of blades, the plurality of blades being rounded and configured such that cutting edges of the blades align longitudinally along the length of the cutting head and sweep an area with a spin motion of the cutting head.

### FIELD

Example embodiments of the inventive concept relate to an electric hair trimmer.

### BACKGROUND

Electric hair trimmers or clippers are commonly used by stylists, barbers, or individuals for styling hair, and typically include a handle having housing for enclosing a motor and a blade assembly associated with the handle. The blade assembly is generally fixed to the handle at a certain orientation for receiving driving power from the motor. A blade set in the blade assembly includes a stationary blade and a moving blade reciprocating laterally and substantially parallel relative to the stationary blade to provide a scissors-type cutting action.

Conventional hair trimmers are difficult to orient in different direction to reach an area that is narrow and difficult to cut, such as behind the ears or the nape of the neck. The entire trimmer must be maneuvered to change the orientation of the blades and reach an area to cut. Such movement may be awkward, and often causes discomfort to the user's wrist or hand after continued use, and also decreases the accuracy and/or efficiency of the trimming because in the conventional trimmers, the cutting edges of the blades are not entirely in contact with the cutting area.

U.S. Pat. No. 5,970,616 to Wahl et al. discloses a hair trimmer having a lighted rotating head. In Wahl, a cutting surface extends at an angle from a blade housing that is rotatable with respect to a main body of the hair trimmer.

Japanese patent application JP 02-052688 discloses a trimmer comb having a toothed front side, where the tip of each trimmer comb tooth has a hemispherical nose for assuring a pleasant skin contact.

International patent application WO 2007/069177 A2 discloses thickened tips of trimmer comb teeth.

Conventional trimmer blades are therefore not satisfactory for detailed trimming or cutting of hair. Therefore, a more comfortable, easy-to-use solution for detailed cutting, including point trimming, contour cutting and small area cutting is needed.

### SUMMARY

One aspect of the inventive concept can be embodied in a rounded head hair trimmer, comprising: a housing; an electric motor in said housing; a cutting head coupled to said motor; a controller to control an electric current to said motor for controlling a spin motion of the cutting head; wherein said cutting head is rounded and includes a plurality of blades arranged in a plurality of axially spaced circular rings.

Another aspect of the inventive concept can be embodied in a rounded head hair trimmer, comprising: a housing; an electric motor in said housing; a cutting head coupled to said motor; a controller to control electric current to said motor for controlling a spin motion of the cutting head; wherein said cutting head includes a plurality of blades, the plurality of blades being rounded and configured such that cutting edges of the blades align longitudinally along the length of the cutting head and sweep an area with the spin motion of the cutting head.

In an example embodiment, the cutting edge of said blades sweep around an axis of rotation.

In an example embodiment, said housing of the hair trimmer is cylindrical and is made of plastic.

In an example embodiment, the blades form a round and corrugated shape and the cutting edges sweep around the axis of rotation.

In an example embodiment, the cutting head include a pole coupled to the motor and is configured to spin via rotation of the motor. The pole is configured to securely receive and attach the rounded cutting blades.

### BRIEF DESCRIPTION OF THE DRAWINGS

The example embodiments of the inventive concept will be better understood from the following brief description taken in conjunction with the accompanying drawings. The drawing FIGS. 1-4 represent non-limiting, example embodiments.

FIG. 1 shows a rounded head hair trimmer with cutting blades spinning in a circular motion.

FIGS. 2-3 show a rounded head hair trimmer illustrating cutting edges of the blades that are configured longitudinally along a length of the cutting head.

FIG. 4 shows configuration of cutting edges in the rounded head.

### DETAIL DESCRIPTION

The following detailed description refers to the accompanying drawings that illustrate the embodiments of the present inventive concept. Other embodiments are possible and modifications may be made to the embodiments without departing from the spirit and scope of the inventive concept. Therefore, the following detailed description is not meant to limit the inventive concept.

In the following description, reference is made to the accompanying drawings which form a part hereof, and in which is shown by way of illustration specific embodiments in which the inventive concept may be practiced. These embodiments are described in sufficient detail to enable those skilled in the art to practice the inventive concept, and it is to be understood that the embodiments may be combined, or that other embodiments may be utilized and that structural and logical changes may be made without departing from the spirit and scope of the present inventive concept. The following description is, therefore, not to be taken in a limiting sense.

Example embodiments of the inventive concepts or aspects may be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, some dimensions are exaggerated for clarity.

It will be understood that when an element is referred to as being “connected” or “coupled” to another element, it can be directly connected or coupled to the other element or intervening elements may be present.

The terminology used herein is for the purpose of describing particular embodiments only and is not intended to be limiting of example embodiments of the inventive concepts. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example, embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Trimmer is the device that can be used to take the place of scissors when cutting hair. Trimmer is meant for cleaning up the edges, and doing other detailed work. Trimmers are typically also used for grooming facial hair such as beards and mustaches. Hair trimmers are grooming implements used for various cosmetic purposes. Some hair trimmers are designed for trimming nose and ear hair. These types of hair trimmers are generally battery operated, lightweight, and portable. A beard hair trimmer is a grooming tool used for refining a man's beard or mustache. Some hair trimmers may be used on the face, neck, chest, and back. All-in-one hair groomers are capable of trimming fine facial hair, or trimming away stray hairs on the back of the neck.

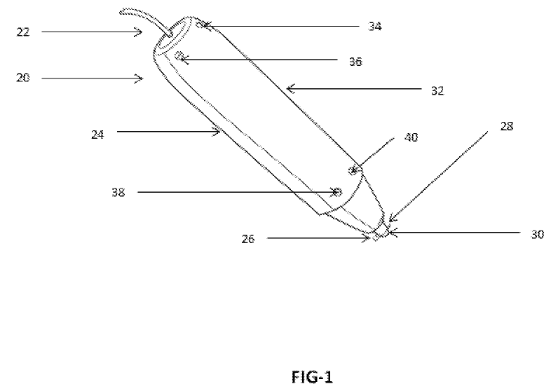

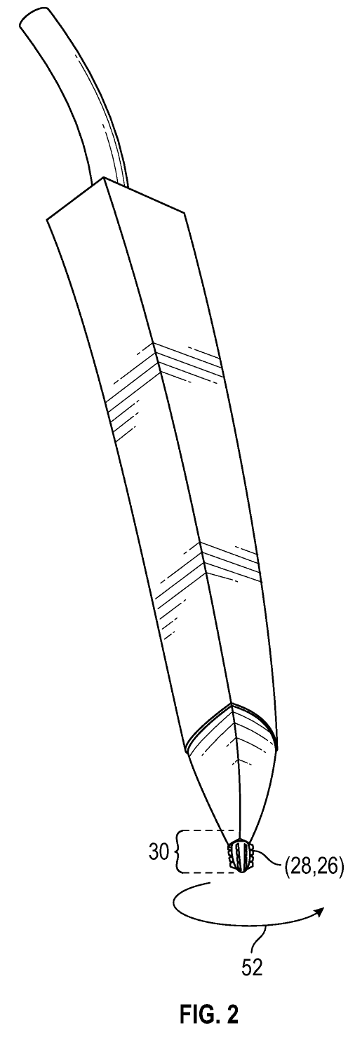

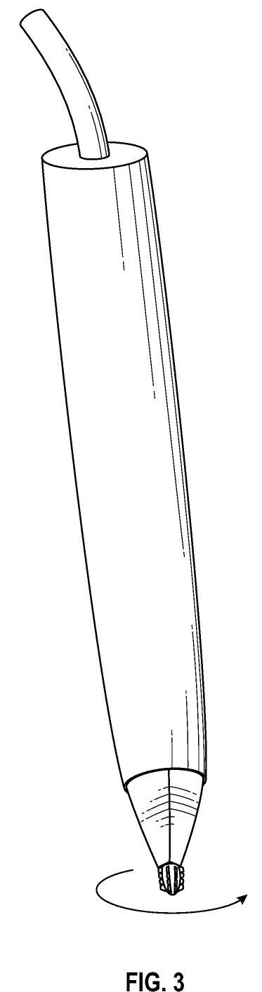

FIG. 1 shows a handheld rounded head hair trimming device 20 comprising plastic cylinder shape body with upper casing 32, lower casing 24, 22, screws 34, 36, 38, and 40, rounded head 30 and cutting blades 28, 26. Rounded head 30 has a metal pole for securing cutting blades 28, 26 to rotate in circular motion. The housing includes a rechargeable battery 53 and a control arrangement to selectively supply current to a motor which is operatively secured inside the plastic cylinder body or upper casing 32. The metal pole is coupled to the motor and is configured to spin as shown by round arrow 52 via the rotation of the motor.

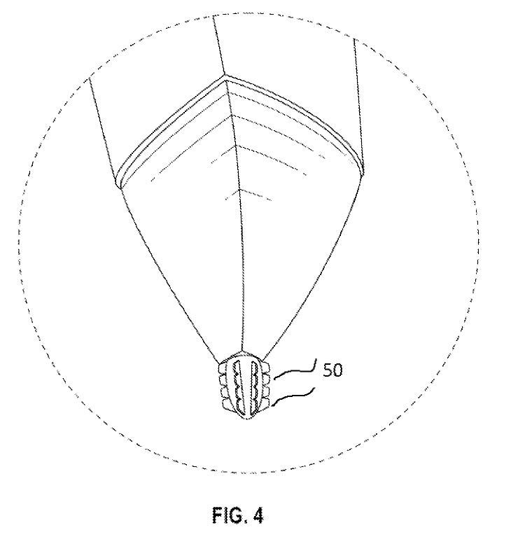

In an example embodiment, as shown in FIG. 4, the metal pole includes rounded cutting edges 50 for trimming hair. The cutting edges 50 are configured longitudinally along the length of the pole. The cutting edges of the pole sweep an area around the axis of rotation of the pole as the pole spins.

In another embodiment, the pole is configured to securely receive and attach the rounded cutting blades and is configured to spin or rotate for cutting or trimming the hair. As the pole spins, cutting edges of the blades rotate or sweep around the axis of rotation of the pole.

In an example embodiment, the control arrangement includes control switches to selectively supply current to the motor to control angular speed or velocity of the pole.

In an example embodiment, the cutting edges include flat and rounded portions and the length of the flat portion is equal in each cutting edges.

In another example embodiment, the cutting edges include flat and rounded portions and the length of the flat portions increase gradually from end to end.

In an example embodiment, the cutting head can be externally coupled to the motor by snap fit mechanism.

In an example embodiment, the rounded head hair trimmer includes a slim cylinder plastic body. A triangular metal zone is formed on an end portion of device and also includes a plurality of hair receiving apertures formed in the cutting head. The metal pole is configured in such a manner that it securely receives blades to rotate in a circular motion.

The hair trimmer device is easy to use and is configured to make more accurate designs in various angles.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present inventive concept have been described above with regard to specific embodiments. These benefits and advantages, and any elements or limitations that may cause them to occur or to become more pronounced are not to be construed as critical, required, or essential features of any or all of the embodiments.

While this specification contains many specific implementation details, these should not be construed as limitations on the scope of any inventive concept of what may be claimed, but rather as descriptions of features that may be specific to particular embodiments of particular inventive concept. Certain features that are described in this specification in the context of separate embodiments can also be implemented in combination in a single embodiment. Conversely, various features that are described in the context of a single embodiment can also be implemented in multiple embodiments separately or in any suitable sub combination.

What is claimed is:

1. A rounded head hair trimmer, comprising:
a housing;
an electric motor in said housing;
a cutting head coupled to said motor;
a controller to control an electric current to said motor for controlling a spin motion of the cutting head; wherein
said cutting head is rounded and includes a plurality of blades arranged in a plurality of axially spaced circular rings.

2. The rounded head hair trimmer of claim 1, wherein the blades are rounded and configured such that cutting edges of the blades align longitudinally along the length of the cutting head.

3. The rounded head hair trimmer of claim 1, wherein said housing is cylindrical.

4. The rounded head hair trimmer of claim 1, wherein said housing is made of plastic.

5. The rounded head hair trimmer of claim 1, wherein said cutting head is rounded.

6. The rounded head hair trimmer of claim 1, wherein said blades spin.

7. The rounded head hair trimmer of claim 1, wherein said rounded head hair trimmer is about 2 inch×2 inch×6 inch in size and about 1 pound in weight.

8. The rounded head hair trimmer of claim 1, wherein the breadth of the rounded head hair trimmer is between 1 inch to 3 inch, thickness is between 1 inch to 3 inch, and height is between 4 inch to 10 inch, and weight is between 0.5-1.5 pounds.

9. The rounded head hair trimmer of claim 1, wherein the cutting edge of said blades sweep around an axis of rotation of the cutting head.

10. The rounded head hair trimmer of claim 1, wherein the blades form a round and corrugated shape and sweep around the axis of rotation of the cutting head.

11. The rounded head hair trimmer of claim 1, wherein the wherein the blades form a round structure such that the cutting head is substantially round or oval.

12. The rounded head hair trimmer of claim 2, wherein the cutting head includes a metal pole coupled to the motor and is configured to receive and attach the rounded cutting blades.

13. The rounded head hair trimmer of claim 2, wherein the cutting head can be externally snap coupled to the motor.

14. The rounded head hair trimmer of claim 2, wherein the plurality of blades can be externally attached to the cutting head.

15. A rounded head hair trimmer, comprising:
a housing;
an electric motor in said housing;
a cutting head coupled to said motor;
a controller to control electric current to said motor for controlling a spin motion of the cutting head; wherein
said cutting head includes a plurality of blades, the plurality of blades being rounded and configured such that cutting edges of the blades align longitudinally along the length of the cutting head and sweep an area with the spin motion of the cutting head.
